(19) United States
(12) Patent Application Publication
(10) Pub. No.: US 2024/0193232 A1
(43) Pub. Date: Jun. 13, 2024

(54) POST SYNDICATION THROUGH ARTIFICIAL INTELLIGENCE CROSS-POLLINATION

(71) Applicant: Meta Platforms, Inc., Menlo Park, CA (US)

(72) Inventors: Brandon Sloane, Lancaster, SC (US); Ryan Sloane, Ventura, CA (US)

(73) Assignee: Meta Platforms, Inc., Menlo Park, CA (US)

(21) Appl. No.: 18/064,694

(22) Filed: Dec. 12, 2022

(51) Int. Cl. G06F 18/2325; G06F 18/2411

(52) U.S. Cl. CPC G06F 18/2325; G06F 18/2411; G06Q 50/01

(57) ABSTRACT

Systems, apparatuses and methods provide technology that identifies a first post that is submitted to a first group of a social network. The technology identifies that the first post is a cross-pollination candidate, identifies a second group of the social network, generates a first vector that is to represent one of the first post or the first group, generates a second vector that is to represent the second group, determines whether the second group matches a cross-pollination criteria based on a comparison of the first vector to the second vector, and determines whether to automatically generate a second post based on the first post, and submit the second post to the second group based on whether the second group matches the cross-pollination criteria.

### BACKGROUND

Social Networks may include individual groups that exist for different reasons. Groups may be a place to communicate about shared interests with certain people. Groups may be created for any number of reasons, such as family reunions, sports teams, book club, cooking interests, hiking, etc. For example, members of a group may share a common interest that is discussed in the group.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes at least one computer readable storage medium that includes a set of instructions. The set of instructions, which when executed by a computing device, causes the computing device to identify a first post that is submitted to a first group of a social network. The set of instructions, which when executed by the computing device, causes the computing device to identify that the first post is a cross-pollination candidate, identify a second group of the social network, generate a first vector that is to represent one of the first post or the first group, generate a second vector that is to represent the second group, determine whether the second group matches a cross-pollination criteria based on a comparison of the first vector to the second vector. The set of instructions, which when executed by the computing device, causes the computing device to determine whether to automatically generate a second post based on the first post, and submit the second post to the second group based on whether the second group matches the cross-pollination criteria. Other examples of this aspect include corresponding computer systems, apparatus, and computer programs recorded on one or more computer storage devices, each configured to perform the actions of the methods.

Some examples relate to a system that includes one or more processors. The system also includes a memory coupled to the one or more processors, the memory including instructions executable by the one or more processors, the one or more processors being operable when executing the instructions to identify a first post that is submitted to a first group of a social network. The one or more processors further being operable when executing the instructions to identify that the first post is a cross-pollination candidate, identify a second group of the social network, generate a first vector that is to represent one of the first post or the first group, generate a second vector that is to represent the second group and determine whether the second group matches a cross-pollination criteria based on a comparison of the first vector to the second vector. The one or more processors further being operable when executing the instructions to determine whether to automatically generate a second post based on the first post, and submit the second post to the second group based on whether the second group matches the cross-pollination criteria. Other examples of this aspect include corresponding computer systems, apparatus, and computer programs recorded on one or more computer storage devices, each configured to perform the actions of the methods.

A method also includes identifying a first post that is submitted to a first group of a social network. The method also includes identifying that the first post is a cross-pollination candidate. The method also includes identifying a second group of the social network. The method also includes generating a first vector that is to represent one of the first post or the first group. The method also includes generating a second vector that is to represent the second group. The method also includes determining whether the second group matches a cross-pollination criteria based on a comparison of the first vector to the second vector. The method also includes determining whether to automatically generate a second post based on the first post, and submit the second post to the second group based on whether the second group matches the cross-pollination criteria. Other examples of this aspect include corresponding computer systems, apparatus, and computer programs recorded on one or more computer storage devices, each configured to perform the actions of the methods.

### BRIEF DESCRIPTION OF THE DRAWINGS

The various advantages of the examples will become apparent to one skilled in the art by reading the following specification and appended claims, and by referencing the following drawings, in which:

FIG. 1 is an example of a cross-pollination process according to an example of the disclosure;

FIG. 2 is a cross-pollination architecture according to an example of the disclosure;

FIG. 3 is a flowchart of an example of a method of determining when a summary of a post should be provided for cross-pollination according to an example of the disclosure;

FIG. 4 is a flowchart of an example of a method of identifying when to compare a first post to groups or other posts according to an example of the disclosure;

FIG. 5 is a flowchart of an example of a method of weighting vectors to determine cross-pollination according to an example of the disclosure;

FIG. 6 is an example of a natural language analysis process according to an example of the disclosure;

FIG. 7 is an example of a vector graph according to an example of the disclosure;

FIG. 8 illustrates an example network environment associated with a social-networking system according to an example of the disclosure;

FIG. 9 illustrates an example social graph according to an example of the disclosure; and

FIG. 10 illustrates an example computer system according to an example of the disclosure.

### DESCRIPTION EXAMPLE

Groups of social networks may have varying levels of privacy. For example, an administrator of a group, may learn more about how to change the privacy level of a group and manage whether people who aren't in the group may find the group in search and other search engines. A public group of a social platform may permit anyone to view content of the public group regardless of whether the viewer is a part of the social platform. A private group may only allow current members of the private group to see content of the private group. Content may not be shared between the different groups in some cases, leading to drawbacks in information propagation and knowledge sharing.

Examples of the disclosure relate to identification of posts for cross-pollination. That is, posts originate in one group of a social platform. In existing examples, such posts would be contained to the one group. Containing such posts to a single group silos knowledge within the single group and creates an insular social platform (e.g., a social-networking system) that lacks versality, knowledge sharing, and the interjection of new ideas. Examples herein identify posts for cross-pollination and shares such posts (or versions of the posts) into different groups to facilitate knowledge sharing, versality, searching (e.g., a post is accessible to relevant groups) and relevance. Doing so enhances the technological field of online information platforms (e.g., social platforms and/or social-networking systems).

Moreover, in order to identify posts for cross-pollination, examples may analyze posts in relation to the other groups. For example, sharing a post with all groups (even if the post is trending) may create unsustainable system clutter, traffic and bandwidth. Moreover, a post that is trending in one group (e.g., a post about whales for an aquatic group) may spark little to no interest in a second group (e.g., a soccer team group). Thus, sharing the post based simply upon the post trending may negatively impact performance, user experience, power, computing resources and so forth. Some examples address the above by executing a cross-pollination analysis to determine whether a post is of interest to other groups based on specific characteristics of the post, the groups and other posts. Doing so mitigates the above discussed negative impacts, therefore improving at least the technological field of online information platforms, social platforms and/or social-networking system. Thus, examples as described herein are an improvement of an existing technology is bolstered by the specification's teachings that the examples achieve benefits over existing implementations, such as increased knowledge sharing flexibility, versality, enhanced searching, and smaller memory requirements.

For example, a user may share a post relating to sale of a hiking backpack to a local hiking group (e.g., a private group). The post, in existing implementations, would be limited to the local hiking group limiting the scope and reach of the post. Examples as described herein may propagate the post to other groups based on an intelligent and dynamic system that analyzes the post and/or local hiking group, compares the post and/or local hiking group to other groups to share the post (or an indicator of the post) with the other groups.

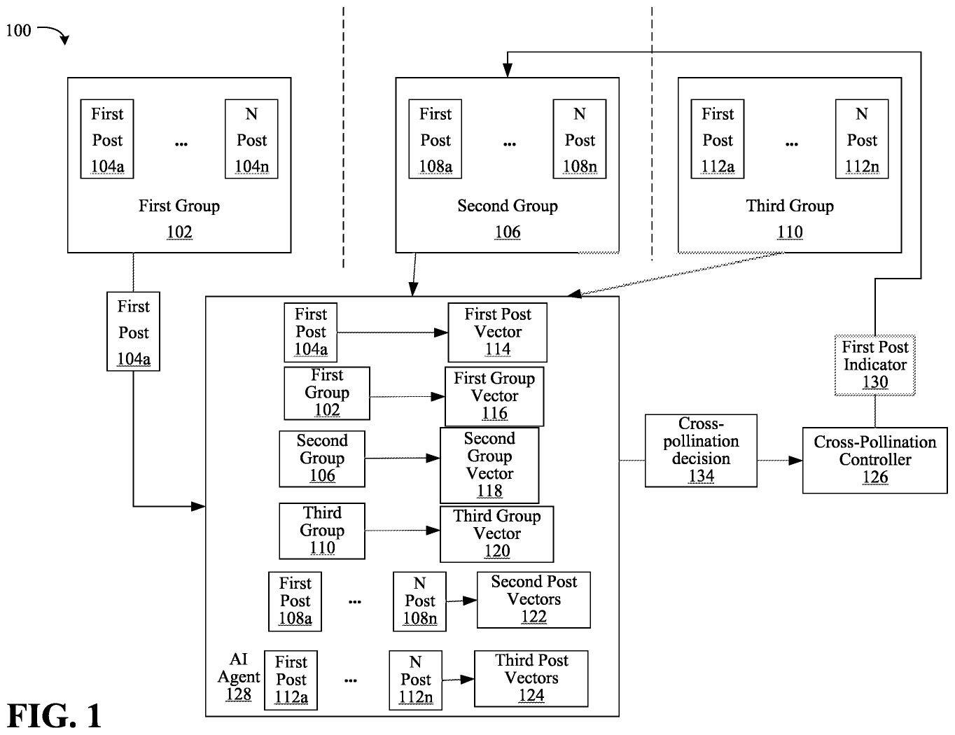

Turning now to FIG. 1, a cross-pollination process 100 is illustrated. The cross-pollination process 100 may be implemented in a computing device including a memory and processor, computing system (e.g., hardware, configurable logic, fixed-function logic hardware, at least one computer readable storage medium comprising a set of instructions for execution, etc.). In the cross-pollination process 100, first group 102, second group 106 and third group 110 are separated from other so that direct communication and/or sharing between the first group 102, the second group 106 and the third group 110 is disallowed. For example, first users of the first group 102 may be unable to access the second group 106 and/or the third group 110 unless specific permission is given to the first users or the first users join the second group 106 and/or the third group 110. Similarly, the second group 106 and third group 110 are isolated from each other. In some examples, the first group 102, the second group 106 and the third group 110 are private groups in which users make a request and be granted permission (e.g., by an administrator) to access content of the first group 102, the second group 106 and the third group 110. In some examples the first group 102, second group 106 and third group 110 are semiprivate groups and/or public groups. Private groups are those with closed memberships and content. Semiprivate groups are those where the membership is based on an approval but the content is public. In other implementations, semiprivate groups are those where the description and membership is visible but maybe the content is private.

The first group 102 includes first post 104a-N post 104n. In this example, a first post 104a is selected for cross-pollination based on one or more criteria. For example, the first post 104a may be selected based on whether the first post 104a is trending (e.g., a number of likes meets a like threshold, a number of views meets a view threshold, a number of comments meets a comment threshold, etc.). In some examples, the criteria may be whether a reply is excepted for the first post 104a and/or is a certain age. For example, if the first post 104a is a request for information, sale, etc. that has not been fulfilled for a certain amount of time, the first post 104a may be selected for cross-pollination to seek satisfaction of the first post 104a through other groups such as the second group 106 and third group 110. In some examples, the criteria may include that the first post 104a is misplaced in the first group 102. For example, if the first post 104a has an interest level (e.g., views, replies, comments, reposting, etc.) that is below a threshold, the first post 104a may be deemed to be misplaced. In such an event, the second and third groups 106, 110 may be analyzed to determine if the first post 104a would be of more interest in the second and third groups 106, 110.

The first post 104a is therefore received and/or identified by the artificial intelligence (AI) agent 128. The AI agent 128 may be a machine learning model. The AI agent 128 analyzes the first post 104a to determine whether to propagate the first post 104a to the second group 106 or the third group 110. In order to do so, the AI agent 128 operates in vector space to compare data that otherwise would be difficult if not impossible to compare. In this example, the first post 104a is mapped to a vector space as the first post vector 114a. Some examples may execute a locality sensitive hashing (LSH) process to map data structures, such as the first post 104a, to the vector space. That is, characteristics of the first post 104a are mapped to the vector space. The first post vector 114 is a representation of the first post 104a in the vector space.

The first group 102, second group 106, third group 110, first post 108a-N post 108n of the second group 106, and the first post 112a-N post 112n of the third group 110 may be mapped to the vector space (e.g., via LSH processes) to facilitate different comparisons and identify whether the second group 106 or the third group 110 is a cross-pollination candidate that should post the first post 104a. For example, the first post 104a may be compared to the second group 106 to identify whether the first post 104a is to be propagated to the second group 106. To execute such a complex and multi-dimensional comparison, examples compare the first post 104a to the second group 106 in the vector space. That is, the first post vector 114 is compared to the second group vector 118. If a distance (e.g., Euclidean distance) between the first post vector 114 and the second group vector 118 below a threshold, the AI agent 128 may deem that the first post vector 114 is sufficiently similar to the second group vector 118 so that the first post 104a should be propagated to the second group 106 to facilitate cross-pollination. If the distance between the first post vector 114 and the second group vector 118 is above the threshold, the AI agent 128 may deem that the first post vector 114 is dissimilar from the second group vector 118 such that the first post 104a should not be propagated to the second group 106. As such, the first post 104a is compared to the second group 106 in vector space to quantify how similar and/or dissimilar the first post 104a is from the second group 106 and determine whether to propagate the first post 104a to the second group 106 accordingly. While a distance is mentioned above, it will be understood that a ranking process may also occur.

In some examples, first post vector 114 and/or the second group vector 118 may be weighted based on identified characteristics of the first post 104a. For example, the AI agent 128 may determine that certain characteristics of the first post 104a are dominant considerations when determining whether to propagate the first post 104a. For example, the first post 104a may include a geographic location (e.g., local only to San Francisco) such that the first post 104a may be of interest only to users within a predetermined location of the geographic location. Thus, a geographic location characteristic of the first post vector 114 and/or the second group vector 118 may be weighted more heavily.

For example, suppose that the first post 104a relates to an offer to sell an item only to users who are able to physically obtain the item and make payment for the item in-person. The first post 104a may therefore have a limited geographic scope and interest to users who are located within a geographic proximity the item. For example, if the item is in San Francisco, then the geographic scope of interest may be San Francisco and surrounding suburbs of San Francisco. As such, if the second group 106 includes members that are completely outside of San Francisco and the suburbs of San Francisco, the first post 104a would be irrelevant for the second group 106. If the second group 106 has members located within San Francisco, then the first post 104a may be relevant for the second group 106.

The geographic locations of the users of the second group 106 may be derived from profiles of the members, an identification of the geographic location of the second group 106, etc. In some examples, the second group 106 may include an explicit field (e.g., geographic field indicating that the location is San Francisco) that is set by an administrator of the second group 106. Regardless of how the geographic location of the second group 106 is identified, the second group vector 118 may include a geographic characteristic that corresponds to the geographic location of the second group 106. The geographic characteristic may be more heavily weighted to increase the influence that geography has on the distance between the second group vector 119 and the first post vector 114. For example, the geographic characteristic of the second group vector 118 and a geographic characteristic of the first post vector 114 may be weighted so that a pre-requisite to the distance being under the threshold is that the geographic characteristics match each other.

Thus, some examples execute trend analysis and layer on intelligence which takes into account topicality and relative importance of the first post 104a to any subset of the second group 106 or the third group 110 which may potentially serve as a samples set of cross-pollination efforts. As an example, if the first post 104a is a post about a sale on backpacks in the first group 102 (e.g., a California hiking group), the first post 104a might have a high potential for relative importance to the second group 106 if the second group 106 is a hiking group (e.g., an East coast hiking group). The same first post 104a might have a lower potential for relative importance to the third group 110 which may be a hiking group in India or China (with the underlying assumption in this example being that what American consumers value might not be the same things that Indian or Chinese consumers value and/or geographic distance makes it difficult if not impossible to consummate trades and/or transactions for items).

While geographic characteristics were specifically identified as being the weighted characteristics above, other types of characteristics may be similarly weighted depending on the content of the first post 104a. For example, a few example categories of characteristics include demographics, geographic, economic, cultural, and religious to etc. For example, the AI agent 128 may identify a content of the first post 104a to determine a topic of the first post 104a. The AI agent 128 may weight characteristics pertaining to the topic in both the first post vector 114 and the second group vector 118. For example, the AI agent 128 may employ natural language processing to identify the topic of the first post 104a based on words mentioned in the first post 104a. For example, the AI agent 128 may identify that words (e.g., business, dealings, exchange, industry, etc.) associated with a economics appears a certain number of times in the first post 104a. The AI agent 128 may then classify the first post 104a as corresponding to economics based on the words associated with the economics (e.g., the topic) meeting a topic threshold. In some examples, the AI agent 128 includes a list of words that are associated with different topics. For example, the words “business, dealings, exchange and industry” may be associated with economics, while the words associated with field goal, punter, quarterback, etc. may be associated with the topic football. If the number of words from the first post 104a pertaining to a specific topic is above a threshold, the first post 104a may be deemed to pertain to the specific topic and characteristics in the first post vector 114 and the second group vector 118 may be more heavily weighted.

In some examples, in addition to and/or instead of the above, some examples increase the granularity of the comparisons so that the first post 104a is compared to a post of the first post 108a-N post 108n of the second group 106n. For example, the first post 108a-N post 108n may be analyzed to determine which types of posts are the most successful (e.g., have the most views, comments, likes, reshares, etc.) in the second group 106. For example, the AI agent 128 may detect trending posts of the first post 108a-N post 108n that have interest levels above a threshold (e.g., as measured by interactions measured through viewing time, likes, reshares, comments, etc.). The interest levels are interest levels of users of the second group 106 in each of the first post 108a-N post 108n. The AI agent 128 may compare the first post 104a to each of such trending posts to predict whether the first post 104a would be of interest to the second group 106. For example, trending vectors of the second post vectors 122 may be vector representations of the trending posts. The first post vector 114 may be compared to each of the trending vectors to identify whether the first post vector 114 is similar to a vector of the trending vectors. If so, the first post 104a may be deemed to be similar to a vector of the trending posts that corresponds to the one or more trending vectors. The first post 104a may then be predicted to be of interest to the second group 106 based on the first post 104a being similar to the one or more trending posts and propagated to the second group 106 based on as much. In doing so, the first post 104a may be accurately analyzed to determine a potential level of interest to the second group 106.

Thus, even if the first post 104a is not trending in the first group 102, the first post 104a may nonetheless be cross-pollinated to other groups if the first post 104a is similar to trending posts in the other groups. For example, if the first post 104a has an interest level in the first group 102, the first post 104a may be compared to other posts to determine if the first post 104a may be a better fit (e.g., more appealing) to another group. Doing so may remedy situation where posts contain interesting content but are submitted to a group that is uninterested in the content. Such posts can be cross-pollinated to groups that are interested in such content.

Similar to the above, the third group 110 may be mapped to the vector space as the third group vector 120 and the first-N posts 112a-112n of the third group 110 may be mapped to the vector space as the third post vectors 124. The first post vector 114 may be compared (e.g., calculate distances) to the third group vector 120 and/or the third post vectors 124 to determine whether to propagate the first post 104a to the third group 110.

In some examples, the first group vector 116 may also be compared to the second group vector 119 and the third group vector 120. Doing so may identify similar groups across which cross-pollination is effective. Thus, if the first group vector 116 is similar to the second group vector 118 (e.g., distance therebetween is below a threshold), the probability of propagating the first post 104a to the second group 106 may increase. If the first group vector 116 is dissimilar from the second group vector 118 (e.g., distance therebetween is above a threshold), the probability of propagating the first post 104a to the second group 106 may decrease. Thus, the first post 104a may be propagated to the second group 106 if the first group vector 116 is similar to the second group vector 118.

The AI agent 128 may determine whether the second group 106 and the third group 110 are cross-pollination candidates as follows and based on whether vectors are similar to each other. In this example, the distance between the first post vector 114 and the third group vector 120, and/or each of the distances between the first post vector 114 and the third post vectors 124 is above a threshold such that the first post vector 114 is determined to be of minimal interest to the third group 110. Thus the first post 104a is determined to not be propagated to the third group 110 (i.e., is not a cross-pollination candidate). The distance between the first post vector 114 and the second group vector 118, and/or a distance of the distances between the first post vector 114 and the second post vectors 122 is below a threshold such that the first post vector 114 is determined to be of significant interest to the second group 106 and thus is determined to be propagated to the second group 106 (i.e., is a cross-pollination candidate).

Further still, to determine whether the second group 106 and the third group 110 are cross-pollination candidates, examples may identify a constraint associated with the second group 106. For example, the constraint may be that all posts to the second group 106 include a picture, description, link, are fact-checked, etc. Such examples may further determine whether the first post 104a meets the constraint, and determine whether the second group 106 matches the cross-pollination criteria based on whether the first post 104a meets the constraint. If the first post 104a meets the constraint, the second group 106 may be deemed to be a cross-pollination candidate. If the first post 104a does not meet the constraint, the second group 106 may be deemed to not be a cross-pollination candidate.

The AI agent 128 outputs a cross-pollination decision 134 that summarizes which group(s) of the second and third groups 106, 110 the first post 104a are selected for cross-pollination (i.e., are cross-pollination candidates) with the first post 104a. The cross-pollination controller 126 receives the cross-pollination decision 134 and determines that the first post 104a is to be transmitted to the second group 106. For example, the cross-pollination controller 126 may propagate the first post indicator 130 to the second group 106 based on the above analysis.

In some examples, the cross-pollination controller 126 analyzes the first group 102 (an originating group for the first post 104a) and second group 106 (destination group for data from the first post 104a) to determine whether group-wide restrictions are in place. The cross-pollination controller 126 may be part of AI agent 128. In some implementations the cross-pollination controller 126 may be a simple rule-based engine. For example, the cross-pollination controller 126 analyzes the first group 102 to determine whether the first group 102 enforces privacy restrictions (e.g., privacy restriction constraints). An example privacy restriction is that posts cannot be shared with users external to the first group 102. In some examples, the first post 104a may have a privacy restriction (e.g., privacy restriction constraints) explicitly provided by an author of the first post 104a. In some examples, the second group 106 may be analyzed to determine if a privacy restriction (e.g., privacy restriction constraints) is in place for the second group 106. For example, the second group 106 may have a constraint that certain data (e.g., personal data) is not shared over the second group 106. The cross-pollination controller 126 analyzes whether a privacy restriction (e.g., privacy restriction constraints) is in place for any of the first group 102, the first post 104a and the second group 106 and modifies the first post accordingly to comport with the privacy restriction.

For example, the cross-pollination controller 126 may remove personal data from the first post 104a to generate the first post indicator 130. That is, the first post indicator 130 may omit personal details from the first post 104a but include other information from the first post 104a. In some examples, the cross-pollination controller 126 shares public content by generating a link (e.g., a post or thread) that is associated and/or cited withing the first post 104a (e.g., original trending content). In some examples, to comport with the privacy restriction, the cross-pollination controller 126 generates a content summary by using a language processing algorithm (e.g., natural language processing) on the first post 104a, extracting relevant details from the first post 104a and presenting the summary as the first post indicator 130 when the first group 102 (e.g., a source of the content) of the first post 104a is a private group. For example, the cross-pollination controller 126 may use natural language processing to distill out the core elements of the first post 104a, cascade conversations (e.g., comments from the first group 102), threads and then generate a summary version of the first post 104a based on the core elements, cascade conversations, threads, etc.

Thus, the first post indicator 130 is shared with the second group 106. The first post indicator 130 may be the first post 104a, a redacted version of the first post 104a or a summary of the first post 104a. Thus, the cross-pollination process 100 automates content sharing based on the AI result of the AI agent 128 to facilitate knowledge sharing and improves existing social-network architectures and technological areas. While a social network is described above, it will be understood that the above may apply to other types of platforms such as information platforms.

As noted, there are any number of metrics which the AI agent 128 may embed the cross-pollination analysis. In some examples, interest and relative trending values may vary depending on various characteristics of groups and posts which have been identified as being important to emphasize. A few example categories of characteristics include demographics, geographic, economic, cultural, and religious to name but a few. Each of these categories might have any number of characteristics. Each of these characteristics then, might have a measure of importance or scale by which posts, such as the first post 104a, may be measured against for relative interest in other groups. Similarly, each respective group of the first, second and third groups 102, 106, 110 may define or may be pre-defined, a degree to which different characteristics may play a role in determining interest for that respective group. The determination about whether or not to post to a particular group may evaluate both the post characteristics and the different target group characteristics and determine if enough of a match is met such that thresholds are exceeded to justify a crosspollination event.

Thus, examples herein identify the first post 104a is submitted to the first group 102 of the social network. The examples identify that the first post 104a is a cross-pollination candidate and provide the first post 104a to the AI agent 128. The examples identify the second group 106 of the social network. The examples then generate a first vector, referred to as a first post vector 114, that is to represent one of the first post 104a or the first group 102. The examples generate a second vector, that is the second group vector 118, that represents the second group 106. The examples then determine whether the second group 106 matches a cross-pollination criteria based on a comparison of the first vector to the second vector, and determines whether to automatically generate a second post, referred to as the first post indicator 130, based on the first post, and submit the second post to the second group 106 based on whether the second group 106 matches the cross-pollination criteria.

In some examples, an opt-into process may be applied to avoid cross-pollination of posts where authors prefer to not cross-pollinate. Thus, an author may be asked to grant explicit permission to cross-pollinate the first post 104a. In some examples, a scoring mechanism may be applied to calculates sensitivity of the first post 104a and determines whether to cross-pollinate or not. If the first post 104a is deemed to be sensitive, the process 100 may be bypassed. Otherwise, the process 100 proceeds as described above.

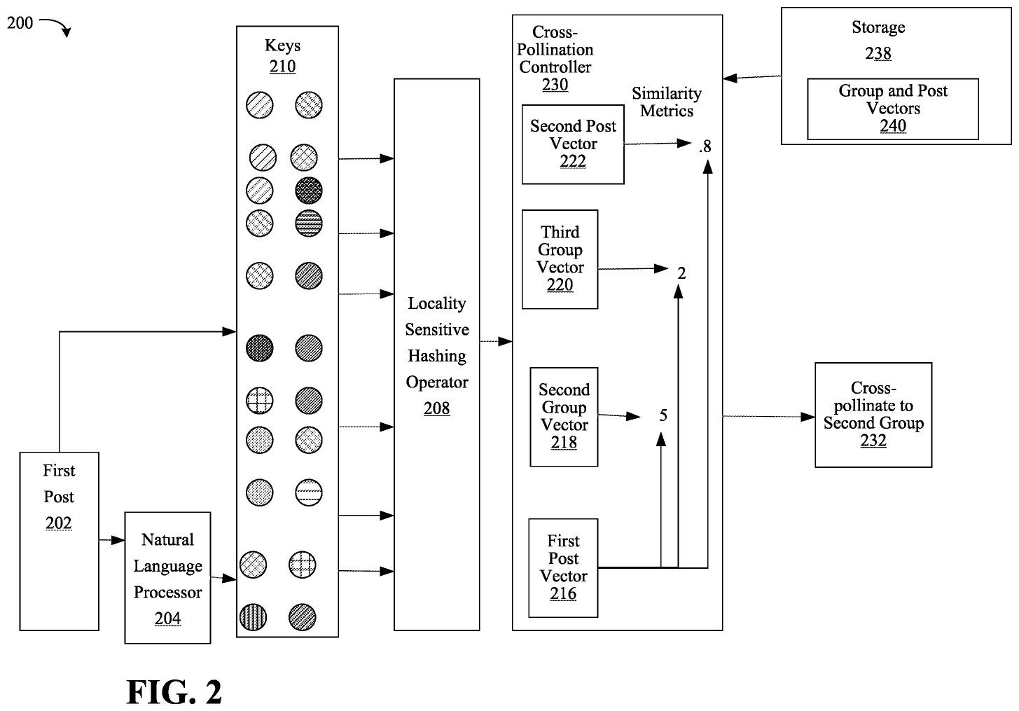

Turning now to FIG. 2, a cross-pollination architecture 200 is illustrated. The cross-pollination architecture 200 may be a computing architecture and may be readily incorporated in or operated in conjunction with the process 100. For example, the cross-pollination architecture 200 may be implemented in a computing device including a memory and processor, computing system (e.g., hardware, configurable logic, fixed-function logic hardware, at least one computer readable storage medium comprising a set of instructions for execution, etc.). Any and all components of the cross-pollination architecture 200 may be implemented as a computing device, non-transitory computer readable storage medium, server, mobile device, etc.

In this example, a first post 202 is identified and/or provided to the cross-pollination architecture 200. The first post 202 may include several fields that are readily identifiable (e.g., fields that are input by a user, such as location, topic such as item for sale, title, etc.). In some examples, the cross-pollination architecture 200 provides a series of prompts to an author of the first post 202 to gather answers comprising data attributes and characteristics about the first post 202. Such fields and/or answers may be directly hashable by an LSH operator 208 and are stored as part of the keys 210.

The first post 202 may also include data in a second format that is not directly hashable by the LSH operator 208. For example, part of the first post 202 may be in a textual format authored by a user (e.g., free-form style). In order to handle the data in the second format, some examples include natural language processor 204 that executes NLP on the data to identify relevant content of the text and provide the relevant content to the LSH operator 208 while ignoring irrelevant content. In some examples, the natural language processor 204 receives a natural language input of the first post 202, applies NLP to the natural language input to filter the natural language input into first text that bypasses (does not include) second text of the natural language input. The first text (but not the second text) may be stored as part of keys 210.

Keys 210 may represent different characteristics of the first post 202. For example, each circle may correspond to a different characteristic of the first post 202. That is, the first post 202 may include multi-dimensional characteristics. A first characteristic may reflect a geographic location of the first post 202, a second characteristic may reflect a topic of the first post 202, a third characteristic may reflect a demographic of an author of the first post 202, and so forth. The characteristics may be represented in the keys 210 regardless of the specific nature of the characteristics.

The LSH operator 208 may receive the keys 210 and execute LSH (e.g., a simhash function or a minhash function) on the keys 210. A simhash function is a technique for quickly estimating how similar two sets are. Simhash may include similar items being hashed to similar hash values (e.g., based on bitwise hamming distance between hash values). The minhash function, or the min-wise independent permutations locality sensitive hashing scheme, is another technique for estimating how similar two sets are. For example, minhash may include a Jaccard similarity coefficient which is an indicator of the similarity between two sets. In Equation 1 below, let U be a set, and A and B be subsets of U, then the Jaccard index is defined to be the ratio of the number of elements of their intersection and the number of elements of their union:

$$J ( A , B ) = \frac{\vert A ⋂ B \vert}{\vert A ⋃ B \vert} \qquad Equation 1$$

This value is 0 when the two sets are disjoint, 1 when they are equal, and strictly between 0 and 1 otherwise. Two sets are more similar (i.e. have relatively more members in common) when their Jaccard index is closer to 1. The goal of MinHash is to estimate J(A,B) quickly, without explicitly computing the intersection and union.

For example, let h be a hash function that maps the members of U to distinct integers, let perm be a random permutation of the elements of the set U, and for any subset S of (define hₘᵢₙ(S) to be the minimal member of S with respect to h∘perm. Some examples may apply hₘᵢₙ to both A and B, and assuming no hash collisions, examples determine that are equal (hₘᵢₙ(A)=hₘᵢₙ(B)) if and only if among all elements of |A∪B|, the element with the minimum hash value lies in the intersection |A∪B|. The probability of this being true is approximately the Jaccard index, therefore:

Pr[hₘᵢₙ(4)=hₘᵢₙ(B)]=J(A,B) Equation 2

For example, the probability that hₘᵢₙ(A)=hₘᵢₙ(B) is true is equal to the similarity J(A,B), assuming drawing perm from a uniform distribution. In other words, if r is the random variable that is one when hₘᵢₙ(A)=hₘᵢₙ(B) and zero otherwise, then r is an unbiased estimator of J(A,B). r has too high a variance to be a useful estimator for the Jaccard similarity on its own, because is always zero or one. A MinHash scheme reduces this variance by averaging together several variables constructed in the same way.

A normal hashing function may accept a string as an input and maps the string to a random, fixed length representation. In post and class ingestion terms, such a hash model would take a series of data attributes (i.e., characteristics) about an identified post/class and convert the attributes into a fixed length vector representation of the attributes. The random generation of fixed length representations results in difficulty identifying similar posts and/or groups.

A LSH function may accept a string as an input, and then maps the string to a fixed length representation but does so in such a way that the input data attributes will influence the representation. In other words, randomness of outputs is constrained based on input variables. In post/class ingestion terms, an LSH function groups similar posts/classes together as vector representations. That is, the LSH function will cluster similar characteristics together to be proximal to each other. For example, LSH may include different functions (known as LSH families) to hash data points into buckets so that data points near each other (e.g., similar characteristics of posts and/or groups) are located in the same buckets with high probability, while data points far from each other (e.g., dissimilar characteristics of posts and/or groups) are likely to be in different buckets. Thus, the LSH operator 208, which implements an LSF function(s), will group similar characteristics into similar buckets.

A vector may be generated based on the groupings of the keys 210. For example, each respective characteristic of the characteristics of the first post 202 is represented as a respective key, and the respective key may be assigned into a bucket by the LSH operator 208. An entry in a first post vector 216 that corresponds to the respective characteristic may be assigned a value corresponding to the bucket (e.g., 1, 2, 3, etc.) that the respective characteristic is assigned. Thus, the characteristics of the first post 202 may be represented as the first post vector 216, where each dimension of the first post vector 216 corresponds to a different characteristic that is sorted into a different bucket value. Thus, each of the characteristics is represented as a dimension of the first post vector 216.

A storage 238 may be accessed to retrieve vectors from group and post vectors 240. For example, the cross-pollination architecture 200 may have previously generated vectors based on previously identified groups and posts of those groups. Thus, the group and post vectors 240 may store previously identified vectors. It is worthwhile to note that the first post 202 may originate with a first group.

In this example, the second group vector 218, the third group vector 220 and the second post vector 222 are retrieved from the group and post vectors 240. The second group vector 118 represents a second group for posts (e.g., a private or semi-private group). The third group vector 220 represents a third group for posts (e.g., a private or semi-private group). The second post vector 222 represents a post from the second group.

A cross-pollination controller 230 determines if the first post vector 216 is similar to a vector of the second group vector 218, third group vector 220 or second post vector 222. If the first post vector 216 is similar to a vector of the second group vector 118, third group vector 220 or second post vector 222, the first post 202 may be propagated to a corresponding group. For example, some examples include an analytics and intelligence aspect which leverages a number of vector and matrix similarity algorithms to examine relatedness from a geographic and weighted dimensional aspect. For example, using eigen-decomposition to examine the most significant factors in the first post vector 216, second group vector 218, third group vector 220 or second post vector 222 (e.g., n-dimensional representations) allows examples to derive insights into relatedness that are the most related along a significant axis. This permits examples to draw insights whether the first post 202 should be cross-pollinated. Some examples may further calculate the similarity between two vectors based on Euclidian distance, Cosine similarity, etc.

In this example, the first post vector 216 is compared to each of the second group vector 118, third group vector 220 and the second post vector 222. If the first post vector 216 is found to be dissimilar to each of the second group vector 218, third group vector 220 and the second post vector 222 may not be cross-pollinated. If however, the first post vector 216 is found to be similar a vector of the second group vector 218, third group vector 220 and the second post vector 222, examples may determine the first post 202 should be cross-pollinated to a corresponding group.

In this example, a similarity metric based on Euclidean Distance (e.g., inversely related to similarity), vector and matrix similarity algorithms, eigen-decomposition, etc. are illustrated. Furthermore, the farther the represented Euclidean distances are from each other, the less similar the corresponding items would be considered. In this example, the highest similarity metric is between the second group vector 218 and the first post vector 216 at 5, which meets a threshold. Thus, the first post 202 may be propagated to the second group which represents the second group vector 218. In contrast the third group vector 220, which represents the third group, have a similarity metric of 2 which fails to meet the threshold. Thus, the first post vector 216 is not propagated to the third group represented by the third group vector 220. Thus, the output is to cross-pollinate to the second group 232.

Examples implement an LSH algorithm that operates to cluster similarly defined items. The items would be different posts and groups which have been gathered and ingested. LSH implementations then cluster related posts and groups together into vector representations which are geographically closer together. This clustering allows examples to run additional analysis against a particular subsets of cross-pollination inquiries.

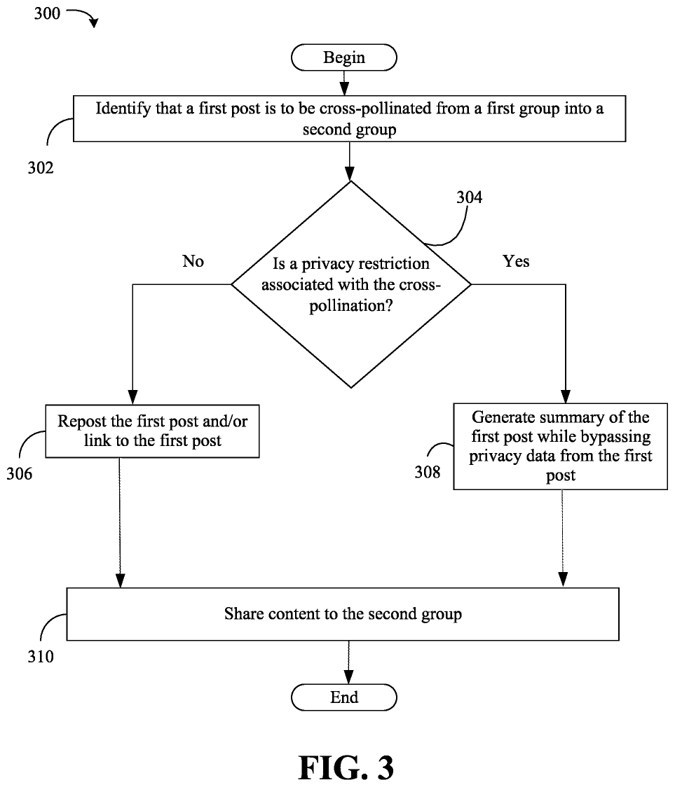

FIG. 3 illustrates a method 300 to determine when a summary of a post should be provided for cross-pollination. One or more aspects of method 300 may be implemented as part of and/or in conjunction with the cross-pollination process 100 (FIG. 1) and/or cross-pollination architecture 200 (FIG. 2). Method 300 may be implemented in a computing device, computing system (e.g., hardware, configurable logic, fixed-function logic hardware, at least one computer readable storage medium comprising a set of instructions for execution, etc.).

Illustrated processing block 302 identifies that a first post is to be cross-pollinated from first group into a second group. Illustrated processing block 304 determines if a privacy restriction is associated with the cross-pollination. For example, a privacy restriction may originate with the first group, the second group or the first post. If so, illustrated processing block 308 generates a summary of the first post while bypassing privacy data from the first post. That is, the privacy data is excluded from the summary. If processing block 304 determines that a privacy restriction is not associated with the cross-pollination, illustrated processing block 306 reposts the first post and/or a link to the first post. Illustrated processing block 310 shares content (either the summary, the first post or the link) to the second group.

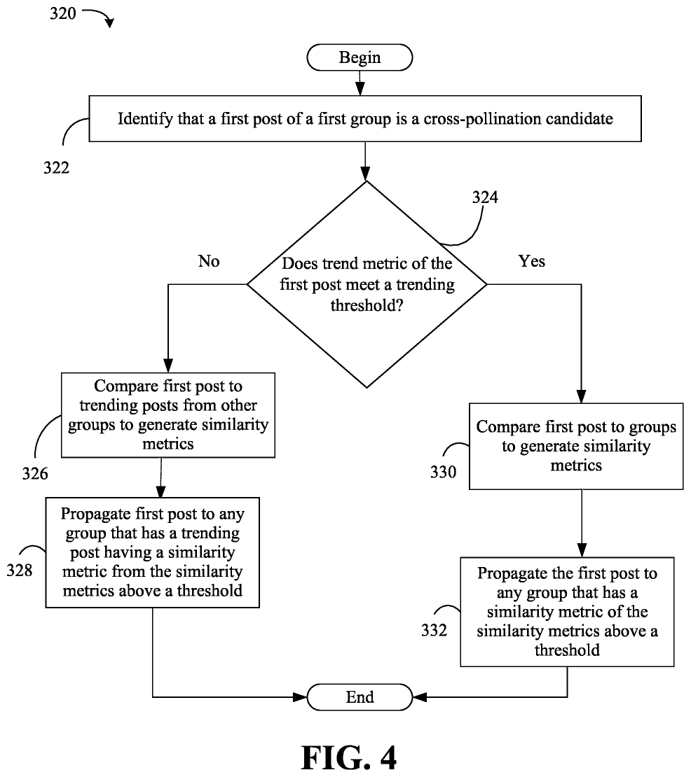

FIG. 4 illustrates a method 320 to identify when to compare a first post to groups or other posts. One or more aspects of method 320 may be implemented as part of and/or in conjunction with the cross-pollination process 100 (FIG. 1), cross-pollination architecture 200 (FIG. 2) and/or method 300 (FIG. 3). Method 320 may be implemented in a computing device, computing system (e.g., hardware, configurable logic, fixed-function logic hardware, at least one computer readable storage medium comprising a set of instructions for execution, etc.).

Illustrated processing block 322 identifies that a first post of a first group is a cross-pollination candidate. Illustrated processing block 324 determines if a trend metric (e.g., likes, views, comments, reshares, etc.) of the first post meets a trending threshold. In other words, processing block 324 determines if the first post is trending. If so, it may be assumed that the first post contains interesting content and may be cross-pollinated to groups that are similar to the first post. Illustrated processing block 330 therefore compares the first post to groups to generate similarity metrics. Illustrated processing block 332 propagates the first post to any group that has a similarity metric of the similarity metrics above a threshold.

If processing block 324 determines that the trend metric of the first post does not meet the trending threshold (e.g., first post is not trending), illustrated processing block 326 compares the first post to trending posts from other groups to generating similarity metrics between the first post and each of the trending posts. Doing so determines if the first post may be better suited and/or better received in another group. That is, the first post may contain content that is not interesting for members of the first group, but may be engaging and interesting for members of a second group. Comparing the first post to trending posts from other groups may identify when such a situation exists. Illustrated processing block 328 propagates the first post to any group that has a trending post having a similarity metric from the similarity metrics above a threshold.

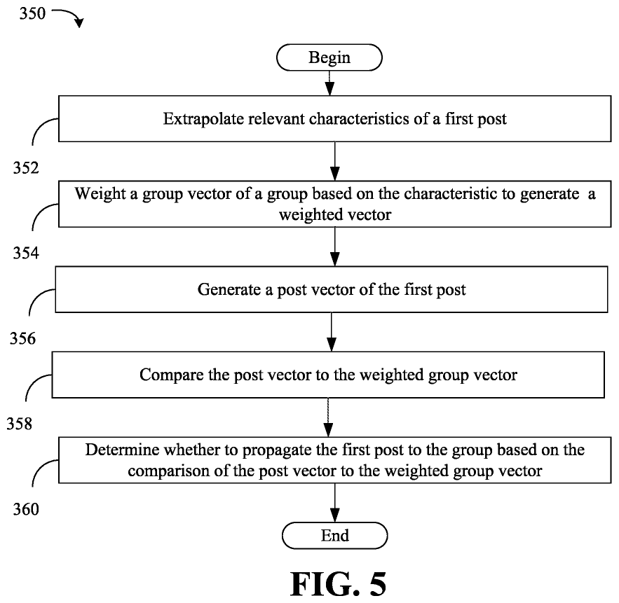

FIG. 5 illustrates a method 350 to weight vectors to determine cross-pollination. One or more aspects of method 350 may be implemented as part of and/or in conjunction with the cross-pollination process 100 (FIG. 1), cross-pollination architecture 200 (FIG. 2), method 300 (FIG. 3) and/or method 320 (FIG. 4). Method 350 may be implemented in a computing device, computing system (e.g., hardware, configurable logic, fixed-function logic hardware, at least one computer readable storage medium comprising a set of instructions for execution, etc.).

Illustrated processing block 352 extrapolates relevant characteristics of a first post. Illustrated processing block 354 weights a group vector of a group based on the characteristics (e.g., topics, geographic location, etc.) to generate a weighted vector. Illustrated processing block 356 generates a post vector for the first post. Illustrated processing block 358 compares the post vector to the weighted group vector (e.g., generate a similarity metric measuring the similarity between the post vector and the weighted group vector). Illustrated processing block 360 determines whether to propagate the first post to the group based on the comparison of the post vector to the weighted group vector (e.g., based on whether the similarity metric meets a threshold). For example, if the similarity metric meets the threshold, the first post may be propagated to the first group. If the similarity metric fails to meet the threshold, the first post may not be propagated to the first group. While the above discusses weighting a group vector, it will be understood that another post vector may be weighted (or the original post vector referenced above).

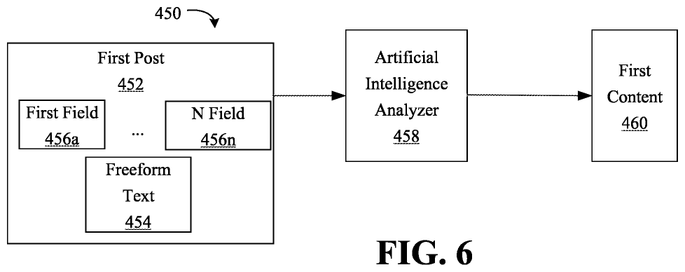

Turning now to FIG. 6, a natural language analysis process 450 is illustrated to identify relevant content from a first post 452. One or more aspects of the natural language analysis process 450 may be implemented as part of and/or in conjunction with the cross-pollination process 100 (FIG. 1), cross-pollination architecture 200 (FIG. 2), method 300 (FIG. 3), method 320 (FIG. 4) and/or method 350 (FIG. 5).

A first post 452 is provided. The first post 452 may be partially in a free form text 454 and includes first field 456a-N field 456n. For example, a user may describe aspects of a system in a free form manner to generate free form text 454. For example, a user may write comments related to different topics, thoughts or considerations. An artificial intelligence analyzer 458 may analyze the free form text 454 to determine subject matter of the free form text. For example, the artificial intelligence analyzer 458 may identify and extract key terminologies as being characteristics and/or topics of the first post 452. For example, the artificial intelligence analyzer 458 receives a natural language input of the free form text 454, applies natural language processing to the natural language input to filter the natural language input into the first content 460.

The artificial intelligence analyzer 458 may also identify the first field 456a-n field 456n. The first field 456a-N field 456n may be fields that are filled out by an author of the first post 452 (e.g., drop down menus requiring specific answers, such as geographic location, topics, for sale, etc.). Content of the first field 456a-N field 456n may be stored as the first content 456.

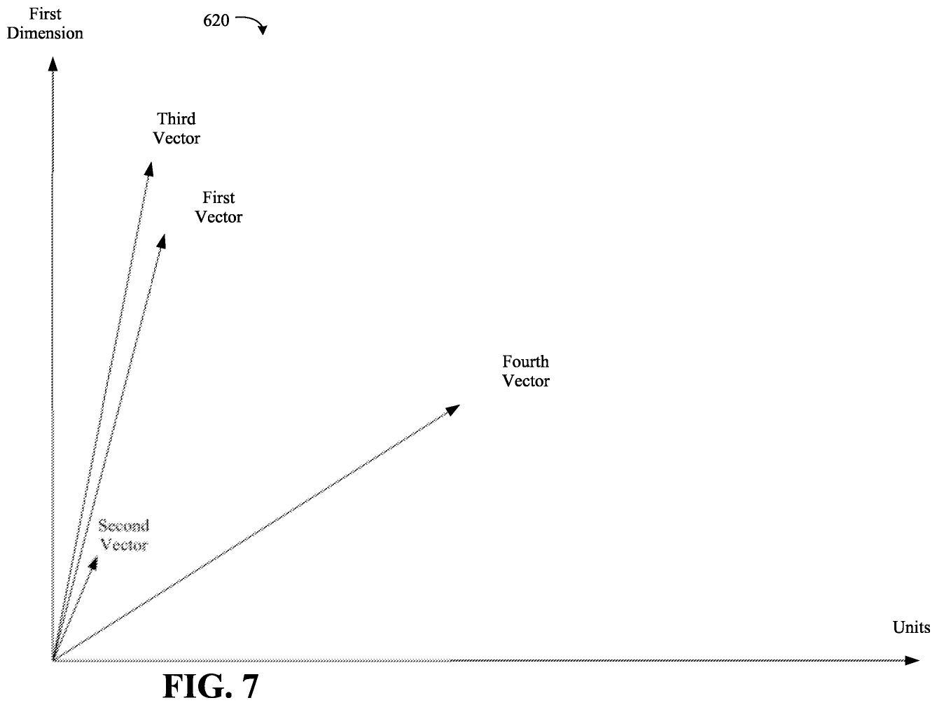

FIG. 7 illustrates a vector graph 620. The vector graph 620 may generally be implemented with the examples described herein, for example, the cross-pollination process 100 (FIG. 1), cross-pollination architecture 200 (FIG. 2), method 300 (FIG. 3), method 320 (FIG. 4), method 350 (FIG. 5) and/or natural language analysis process 450 (FIG. 6) already discussed. The vector graph 620 includes a first vector, second vector, third vector and fourth vector. The first vector, the second vector, the third vector and the fourth vector may represent different posts and/or groups, and may be compared to each other to determine which posts and/or groups are similar to each other.

For example, the first vector (which may correspond to a first post from a first group) may be compared to the second vector (which may correspond to a second group). The first vector and the second vector may have similar slopes, but different magnitudes. That is, the second vector has a magnitude that is substantially smaller than the first vector. Since the magnitudes of the first and second vectors are substantially different from each other, the first and second vectors may be deemed to be different from each other and not similar to each other.

The first vector and the third vector (e.g., a second post from a third group) may be compared to each other. In this example, the first vector and the third vector have similar slopes (e.g., a difference between the slopes is below a slope threshold) and similar magnitudes (e.g., a difference between a magnitude of the first vector and the third vector is below a magnitude threshold). Thus, the first and third vectors are determined to be similar to each other.

The first vector may be compared to the fourth vector (e.g., a fourth group). The first vector and the fourth vector may have substantially different slopes from each other (e.g., a difference between slopes of the first vector and the fourth vector is above the slope threshold). Thus, the first and fourth vectors are determined to be dissimilar from each other.

Based on whether the first-fourth vectors are similar to each other, different propagation strategies may be adopted. For example, in this case, first post represented by the first vector is propagated to the third group based on the first and the third vector being similar to each other.

### System Overview

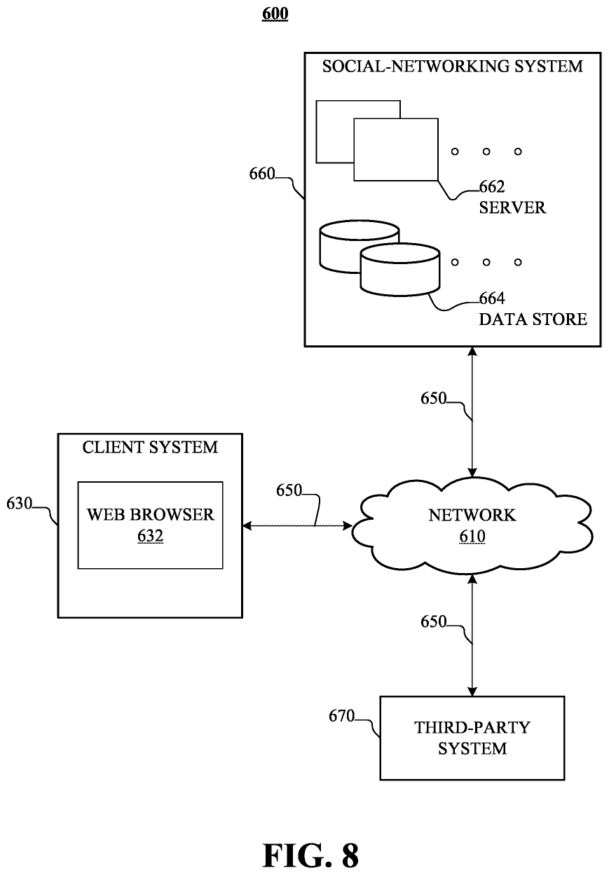

FIG. 8 illustrates an example network environment 600 associated with a social-networking system. Network environment 600 may implement one or more aspects of the cross-pollination process 100 (FIG. 1), cross-pollination architecture 200 (FIG. 2), method 300 (FIG. 3), method 320 (FIG. 4), method 350 (FIG. 5), natural language analysis process 450 (FIG. 6) and/or vector graph 620 (FIG. 7) already discussed.

Network environment 600 includes a client system 630, a social-networking system 660, and a third-party system 670 connected to each other by a network 610. Although FIG. 8 illustrates a particular arrangement of client system 630, social-networking system 660, third-party system 670, and network 610, this disclosure contemplates any suitable arrangement of client system 630, social-networking system 660, third-party system 670, and network 610. As an example and not by way of limitation, two or more of client system 630, social-networking system 660, and third-party system 670 may be connected to each other directly, bypassing network 610. As another example, two or more of client system 630, social-networking system 660, and third-party system 670 may be physically or logically co-located with each other in whole or in part. Moreover, although FIG. 8 illustrates a particular number of client systems 630, social-networking systems 660, third-party systems 670, and networks 610, this disclosure contemplates any suitable number of client systems 630, social-networking systems 660, third-party systems 670, and networks 610. As an example and not by way of limitation, network environment 600 may include multiple client system 630, social-networking systems 660, third-party systems 670, and networks 610.

This disclosure contemplates any suitable network 610. As an example and not by way of limitation, one or more portions of network 610 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 610 may include one or more networks 610.

Links 650 may connect client system 630, social-networking system 660, and third-party system 670 to communication network 610 or to each other. This disclosure contemplates any suitable links 650. In particular examples, one or more links 650 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular examples, one or more links 650 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 650, or a combination of two or more such links 650. Links 650 need not necessarily be the same throughout network environment 600. One or more first links 650 may differ in one or more respects from one or more second links 650.

In particular examples, client system 630 may be an electronic device including hardware, software, or embedded logic components or a combination of two or more such components and capable of carrying out the appropriate functionalities implemented or supported by client system 630. As an example and not by way of limitation, a client system 630 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 630. A client system 630 may enable a network user at client system 630 to access network 610. A client system 630 may enable its user to communicate with other users at other client systems 630.

In particular examples, client system 630 may include a web browser 632, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 630 may enter a Uniform Resource Locator (URL) or other address directing the web browser 632 to a particular server (such as server 662, or a server associated with a third-party system 670), and the web browser 632 may generate a Hyper Text Transfer Protocol (HTTP) request and communicate the HTTP request to server. The server may accept the HTTP request and communicate to client system 630 one or more Hyper Text Markup Language (HTML) files responsive to the HTTP request. Client system 630 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular desires. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular examples, social-networking system 660 may be a network-addressable computing system that can host an online social network. Social-networking system 660 may generate, store, receive, and send social-networking data, such as, for example, user-profile data, concept-profile data, social-graph information, or other suitable data related to the online social network. Social-networking system 660 may be accessed by the other components of network environment 600 either directly or via network 610. As an example and not by way of limitation, client system 630 may access social-networking system 660 using a web browser 632, or a native application associated with social-networking system 660 (e.g., a mobile social-networking application, a messaging application, another suitable application, or any combination thereof) either directly or via network 610. In particular examples, social-networking system 660 may include one or more servers 662. Each server 662 may be a unitary server or a distributed server spanning multiple computers or multiple datacenters. Servers 662 may be of various types, such as, for example and without limitation, web server, news server, mail server, message server, advertising server, file server, application server, exchange server, database server, proxy server, another server suitable for performing functions or processes described herein, or any combination thereof. In particular examples, each server 662 may include hardware, software, or embedded logic components or a combination of two or more such components for carrying out the appropriate functionalities implemented or supported by server 662. In particular examples, social-networking system 660 may include one or more data stores 664. Data stores 664 may be used to store various types of information. In particular examples, the information stored in data stores 664 may be organized according to specific data structures. In particular examples, each data store 664 may be a relational, columnar, correlation, or other suitable database. Although this disclosure describes or illustrates particular types of databases, this disclosure contemplates any suitable types of databases. Particular examples may provide interfaces that enable a client system 630, a social-networking system 660, or a third-party system 670 to manage, retrieve, modify, add, or delete, the information stored in data store 664.

In particular examples, social-networking system 660 may store one or more social graphs in one or more data stores 664. In particular examples, a social graph may include multiple nodes—which may include multiple user nodes (each corresponding to a particular user) or multiple concept nodes (each corresponding to a particular concept)—and multiple edges connecting the nodes. Social-networking system 660 may provide users of the online social network the ability to communicate and interact with other users. In particular examples, users may join the online social network via social-networking system 660 and then add connections (e.g., relationships) to a number of other users of social-networking system 660 to whom they want to be connected. Herein, the term “friend” may refer to any other user of social-networking system 660 with whom a user has formed a connection, association, or relationship via social-networking system 660.

In particular examples, social-networking system 660 may provide users with the ability to take actions on various types of items or objects, supported by social-networking system 660. As an example and not by way of limitation, the items and objects may include groups or social networks to which users of social-networking system 660 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 660 or by an external system of third-party system 670, which is separate from social-networking system 660 and coupled to social-networking system 660 via a network 610.

In particular examples, social-networking system 660 may be capable of linking a variety of entities. As an example and not by way of limitation, social-networking system 660 may enable users to interact with each other as well as receive content from third-party systems 670 or other entities, or to allow users to interact with these entities through an application programming interfaces (API) or other communication channels.

In particular examples, a third-party system 670 may include one or more types of servers, one or more data stores, one or more interfaces, including but not limited to APIs, one or more web services, one or more content sources, one or more networks, or any other suitable components, e.g., that servers may communicate with. A third-party system 670 may be operated by a different entity from an entity operating social-networking system 660. In particular examples, however, social-networking system 660 and third-party systems 670 may operate in conjunction with each other to provide social-networking services to users of social-networking system 660 or third-party systems 670. In this sense, social-networking system 660 may provide a platform, or backbone, which other systems, such as third-party systems 670, may use to provide social-networking services and functionality to users across the Internet.

In particular examples, a third-party system 670 may include a third-party content object provider. A third-party content object provider may include one or more sources of content objects, which may be communicated to a client system 630. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular examples, social-networking system 660 also includes user-generated content objects, which may enhance a user's interactions with social-networking system 660. User-generated content may include anything a user can add, upload, send, or “post” to social-networking system 660. As an example and not by way of limitation, a user communicates posts to social-networking system 660 from a client system 630. Posts may include data such as status updates or other textual data, location information, photos, videos, links, music or other similar data or media. Content may also be added to social-networking system 660 by a third-party through a “communication channel,” such as a newsfeed or stream.

In particular examples, social-networking system 660 may include a variety of servers, sub-systems, programs, modules, logs, and data stores. In particular examples, social-networking system 660 may include or a combination of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 660 may also include suitable components such as network interfaces, security mechanisms, load balancers, failover servers, management-and-network-operations consoles, other suitable components, or any suitable combination thereof. In particular examples, social-networking system 660 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 660 to one or more client systems 630 or one or more third-party system 670 via network 610. The web server may include a mail server or other messaging functionality for receiving and routing messages between social-networking system 660 and one or more client systems 630. An API-request server may allow a third-party system 670 to access information from social-networking system 660 by calling one or more APIs. An action logger may be used to receive communications from a web server about a user's actions on or off social-networking system 660. In conjunction with the action log, a third-party-content-object log may be maintained of user exposures to third-party-content objects. A notification controller may provide information regarding content objects to a client system 630. Information may be pushed to a client system 630 as notifications, or information may be pulled from client system 630 responsive to a request received from client system 630. Authorization servers may be used to enforce one or more privacy settings of the users of social-networking system 660. A privacy setting of a user determines how particular information associated with a user can be shared. The authorization server may allow users to opt in to or opt out of having their actions logged by social-networking system 660 or shared with other systems (e.g., third-party system 670), such as, for example, by setting appropriate privacy settings. Third-party-content-object stores may be used to store content objects received from third parties, such as a third-party system 670. Location stores may be used for storing location information received from client systems 630 associated with users. Advertisement-pricing modules may combine social information, the current time, location information, or other suitable information to provide relevant advertisements, in the form of notifications, to a user.

### Social Graphs

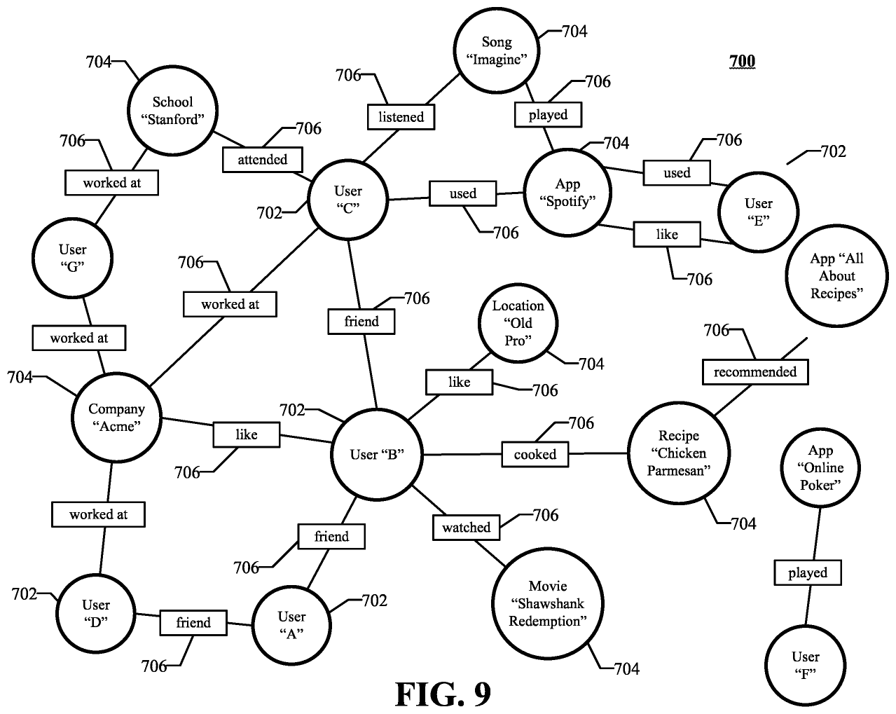

FIG. 9 illustrates example social graph 700. In some examples, the cross-pollination process 100 (FIG. 1), cross-pollination architecture 200 (FIG. 2), method 300 (FIG. 3), method 320 (FIG. 4), method 350 (FIG. 5), natural language analysis process 450 (FIG. 6) and/or vector graph 620 (FIG. 7) already discussed may access social graph 700 to implement one or more aspects.

In particular examples, social-networking system 660 may store one or more social graphs 700 in one or more data stores. In particular examples, social graph 700 may include multiple nodes—which may include multiple user nodes 702 or multiple concept nodes 704 and multiple edges 706 connecting the nodes. Each node may be associated with a unique entity (i.e., user or concept), each of which may have a unique identifier (ID), such as a unique number or username. Example social graph 700 illustrated in FIG. 9 is shown, for didactic purposes, in a two-dimensional visual map representation. In particular examples, a social-networking system 660, client system 630, or third-party system 670 may access social graph 700 and related social-graph information for suitable applications. The nodes and edges of social graph 700 may be stored as data objects, for example, in a data store (such as a social-graph database). Such a data store may include one or more searchable or queryable indexes of nodes or edges of social graph 700.

In particular examples, a user node 702 may correspond to a user of social-networking system 660. As an example and not by way of limitation, a user may be an individual (human user), an entity (e.g., an enterprise, business, or third-party application), or a group (e.g., of individuals or entities) that interacts or communicates with or over social-networking system 660. In particular examples, when a user registers for an account with social-networking system 660, social-networking system 660 may create a user node 702 corresponding to the user, and store the user node 702 in one or more data stores. Users and user nodes 702 described herein may, where appropriate, refer to registered users and user nodes 702 associated with registered users. In addition or as an alternative, users and user nodes 702 described herein may, where appropriate, refer to users that have not registered with social-networking system 660. In particular examples, a user node 702 may be associated with information provided by a user or information gathered by various systems, including social-networking system 660. As an example and not by way of limitation, a user may provide his or her name, profile picture, contact information, birth date, sex, marital status, family status, employment, education background, preferences, interests, or other demographic information. In particular examples, a user node 702 may be associated with one or more data objects corresponding to information associated with a user. In particular examples, a user node 702 may correspond to one or more webpages.

In particular examples, a concept node 704 may correspond to a concept. As an example and not by way of limitation, a concept may correspond to a place (such as, for example, a movie theater, restaurant, landmark, or city); a website (such as, for example, a website associated with social-network system 660 or a third-party website associated with a web-application server); an entity (such as, for example, a person, business, group, sports team, or celebrity); a resource (such as, for example, an audio file, video file, digital photo, text file, structured document, or application) which may be located within social-networking system 660 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 704 may be associated with information of a concept provided by a user or information gathered by various systems, including social-networking system 660. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular examples, a concept node 704 may be associated with one or more data objects corresponding to information associated with concept node 704. In particular examples, a concept node 704 may correspond to one or more webpages.

In particular examples, a node in social graph 700 may represent or be represented by a webpage (which may be referred to as a “profile page”). Profile pages may be hosted by or accessible to social-networking system 660. Profile pages may also be hosted on third-party websites associated with a third-party system 670. As an example and not by way of limitation, a profile page corresponding to a particular external webpage may be the particular external webpage and the profile page may correspond to a particular concept node 704. Profile pages may be viewable by all or a selected subset of other users. As an example and not by way of limitation, a user node 702 may have a corresponding user-profile page in which the corresponding user may add content, make declarations, or otherwise express himself or herself. As another example and not by way of limitation, a concept node 704 may have a corresponding concept-profile page in which one or more users may add content, make declarations, or express themselves, particularly in relation to the concept corresponding to concept node 704.

In particular examples, a concept node 704 may represent a third-party webpage or resource hosted by a third-party system 670. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 630 to send to social-networking system 660 a message indicating the user's action. In response to the message, social-networking system 660 may create an edge (e.g., a check-in-type edge) between a user node 702 corresponding to the user and a concept node 704 corresponding to the third-party webpage or resource and store edge 706 in one or more data stores.

In particular examples, a pair of nodes in social graph 700 may be connected to each other by one or more edges 706. An edge 706 connecting a pair of nodes may represent a relationship between the pair of nodes. In particular examples, an edge 706 may include or represent one or more data objects or attributes corresponding to the relationship between a pair of nodes. As an example and not by way of limitation, a first user may indicate that a second user is a “friend” of the first user. In response to this indication, social-networking system 660 may send a “friend request” to the second user. If the second user confirms the “friend request,” social-networking system 660 may create an edge 706 connecting the first user's user node 702 to the second user's user node 702 in social graph 700 and store edge 706 as social-graph information in one or a combination of data stores 664. In the example of FIG. 9, social graph 700 includes an edge 706 indicating a friend relation between user nodes 702 of user “A” and user “B” and an edge indicating a friend relation between user nodes 702 of user “C” and user “B.” Although this disclosure describes or illustrates particular edges 706 with particular attributes connecting particular user nodes 702, this disclosure contemplates any suitable edges 706 with any suitable attributes connecting user nodes 702. As an example and not by way of limitation, an edge 706 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 700 by one or more edges 706. The degree of separation between two objects represented by two nodes, respectively, is a count of edges in a shortest path connecting the two nodes in the social graph 700. As an example and not by way of limitation, in the social graph 700, the user node 702 of user “C” is connected to the user node 702 of user “A” via multiple paths including, for example, a first path directly passing through the user node 702 of user “B,” a second path passing through the concept node 704 of company “Acme” and the user node 702 of user “D,” and a third path passing through the user nodes 702 and concept nodes 704 representing school “Stanford,” user “G,” company “Acme,” and user “D.” User “C” and user “A” have a degree of separation of two because the shortest path connecting their corresponding nodes (i.e., the first path) includes two edges 706.

In particular examples, an edge 706 between a user node 702 and a concept node 704 may represent a particular action or activity performed by a user associated with user node 702 toward a concept associated with a concept node 704. As an example and not by way of limitation, as illustrated in FIG. 9, a user may “like,” “attended,” “played,” “listened,” “cooked,” “worked at,” or “watched” a concept, each of which may correspond to an edge type or subtype. A concept-profile page corresponding to a concept node 704 may include, for example, a selectable “check in” icon (such as, for example, a clickable “check in” icon) or a selectable “add to favorites” icon. Similarly, after a user clicks these icons, social-networking system 660 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 660 may create a “listened” edge 706 and a “used” edge (as illustrated in FIG. 9) between user nodes 702 corresponding to the user and concept nodes 704 corresponding to the song and application to indicate that the user listened to the song and used the application. Moreover, social-networking system 660 may create a “played” edge 706 (as illustrated in FIG. 9) between concept nodes 704 corresponding to the song and the application to indicate that the particular song was played by the particular application. In this case, “played” edge 706 corresponds to an action performed by an external application (SPOTIFY) on an external audio file (the song “Imagine”). Although this disclosure describes particular edges 706 with particular attributes connecting user nodes 702 and concept nodes 704, this disclosure contemplates any suitable edges 706 with any suitable attributes connecting user nodes 702 and concept nodes 704. Moreover, although this disclosure describes edges between a user node 702 and a concept node 704 representing a single relationship, this disclosure contemplates edges between a user node 702 and a concept node 704 representing one or more relationships. As an example and not by way of limitation, an edge 706 may represent both that a user likes and has used at a particular concept. Alternatively, another edge 706 may represent each type of relationship (or multiples of a single relationship) between a user node 702 and a concept node 704 (as illustrated in FIG. 9 between user node 702 for user “E” and concept node 704 for “SPOTIFY”).

In particular examples, social-networking system 660 may create an edge 706 between a user node 702 and a concept node 704 in social graph 700. As an example and not by way of limitation, a user viewing a concept-profile page (such as, for example, by using a web browser or a special-purpose application hosted by the user's client system 630) may indicate that he or she likes the concept represented by the concept node 704 by clicking or selecting a “Like” icon, which may cause the user's client system 630 to send to social-networking system 660 a message indicating the user's liking of the concept associated with the concept-profile page. In response to the message, social-networking system 660 may create an edge 706 between user node 702 associated with the user and concept node 704, as illustrated by “like” edge 706 between the user and concept node 704. In particular examples, social-networking system 660 may store an edge 706 in one or more data stores. In particular examples, an edge 706 may be automatically formed by social-networking system 660 in response to a particular user action. As an example and not by way of limitation, if a first user uploads a picture, watches a movie, or listens to a song, an edge 706 may be formed between user node 702 corresponding to the first user and concept nodes 704 corresponding to those concepts. Although this disclosure describes forming particular edges 706 in particular manners, this disclosure contemplates forming any suitable edges 706 in any suitable manner.

### Social Graph Affinity and Coefficient

In particular examples, social-networking system 660 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 670 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular examples, social-networking system 660 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular examples, social-networking system 660 may use a variety of factors to calculate a coefficient. These factors may include, for example, user actions, types of relationships between objects, location information, other suitable factors, or any combination thereof. In particular examples, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular examples, the social-networking system 660 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular examples, social-networking system 660 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular examples, social-networking system 660 may calculate a coefficient based on a user's actions. Social-networking system 660 may monitor such actions on the online social network, on a third-party system 670, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular examples, social-networking system 660 may calculate a coefficient based on the user's actions with particular types of content. The content may be associated with the online social network, a third-party system 670, or another suitable system. The content may include users, profile pages, posts, news stories, headlines, instant messages, chat room conversations, emails, advertisements, pictures, video, music, other suitable objects, or any combination thereof. Social-networking system 660 may analyze a user's actions to determine whether one or a combination of the actions indicate an affinity for subject matter, content, other users, and so forth. As an example and not by way of limitation, if a user frequently posts content related to “coffee” or variants thereof, social-networking system 660 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular examples, social-networking system 660 may calculate a coefficient based on the type of relationship between particular objects. Referencing the social graph 700, social-networking system 660 may analyze the number and/or type of edges 706 connecting particular user nodes 702 and concept nodes 704 when calculating a coefficient. As an example and not by way of limitation, user nodes 702 that are connected by a spouse-type edge (representing that the two users are married) may be assigned a higher coefficient than user nodes 702 that are connected by a friend-type edge. In other words, depending upon the weights assigned to the actions and relationships for the particular user, the overall affinity may be determined to be higher for content about the user's spouse than for content about the user's friend. In particular examples, the relationships a user has with another object may affect the weights and/or the ratings of the user's actions with respect to calculating the coefficient for that object. As an example and not by way of limitation, if a user is tagged in a first photo, but merely likes a second photo, social-networking system 660 may determine that the user has a higher coefficient with respect to the first photo than the second photo because having a tagged-in-type relationship with content may be assigned a higher weight and/or rating than having a like-type relationship with content. In particular examples, social-networking system 660 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 660 may determine that the first user should also have a relatively high coefficient for the particular object. In particular examples, the coefficient may be based on the degree of separation between particular objects. The lower coefficient may represent the decreasing likelihood that the first user will share an interest in content objects of the user that is indirectly connected to the first user in the social graph 700. As an example and not by way of limitation, social-graph entities that are closer in the social graph 700 (i.e., fewer degrees of separation) may have a higher coefficient than entities that are further apart in the social graph 700.

In particular examples, social-networking system 660 may calculate a coefficient based on location information. Objects that are geographically closer to each other may be considered to be more related or of more interest to each other than more distant objects. In particular examples, the coefficient of a user towards a particular object may be based on the proximity of the object's location to a current location associated with the user (or the location of a client system 630 of the user). A first user may be more interested in other users or concepts that are closer to the first user. As an example and not by way of limitation, if a user is one mile from an airport and two miles from a gas station, social-networking system 660 may determine that the user has a higher coefficient for the airport than the gas station based on the proximity of the airport to the user.

In particular examples, social-networking system 660 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 660 may provide information that is relevant to user's interests and current circumstances, increasing the likelihood that they will find such information of interest. In particular examples, social-networking system 660 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular examples, social-networking system 660 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular examples, social-networking system 660 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 670 (e.g., via an API or other communication channel), or from another suitable system. In response to the request, social-networking system 660 may calculate the coefficient (or access the coefficient information if it has previously been calculated and stored). In particular examples, social-networking system 660 may measure an affinity with respect to a particular process. Different processes (both internal and external to the online social network) may request a coefficient for a particular object or set of objects. Social-networking system 660 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular examples may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

### Privacy

In particular examples, one or a combination of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular examples, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular examples, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 704 corresponding to a particular photo may have a privacy setting specifying that the photo may only be accessed by users tagged in the photo and their friends. In particular examples, privacy settings may allow users to opt in or opt out of having their actions logged by social-networking system 660 or shared with other systems (e.g., third-party system 670). In particular examples, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 670, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular examples, one or more servers 662 may be authorization/privacy servers for enforcing privacy settings. In response to a request from a user (or other entity) for a particular object stored in a data store 664, social-networking system 660 may send a request to the data store 664 for the object. The request may identify the user associated with the request and may only be sent to the user (or a client system 630 of the user) if the authorization server determines that the user is authorized to access the object based on the privacy settings associated with the object. If the requesting user is not authorized to access the object, the authorization server may prevent the requested object from being retrieved from the data store 664, or may prevent the requested object from being sent to the user. In the search query context, an object may only be generated as a search result if the querying user is authorized to access the object. In other words, the object has a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

### Systems and Methods

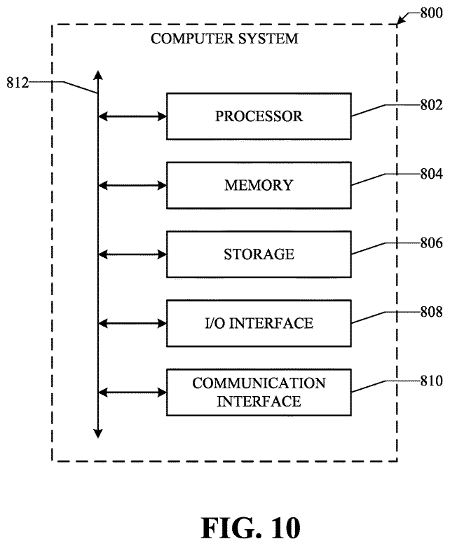

FIG. 10 illustrates an example computer system 800. The system 800 may implement one or more aspects of the cross-pollination process 100 (FIG. 1), cross-pollination architecture 200 (FIG. 2), method 300 (FIG. 3), method 320 (FIG. 4), method 350 (FIG. 5), natural language analysis process 450 (FIG. 6) and/or vector graph 620 (FIG. 7) already discussed. In particular examples, one or more computer systems 800 perform one or more steps of one or more methods described or illustrated herein. In particular examples, one or more computer systems 800 provide functionality described or illustrated herein. In particular examples, software running on one or more computer systems 800 performs one or more steps of one or more methods described or illustrated herein or provides functionality described or illustrated herein. Particular examples include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular examples, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular examples, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular examples, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular examples, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular examples, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or a combination of those results to memory 804. In particular examples, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular examples, one or more memory management units (MMUs) reside between processor 802 and memory 804 and facilitate accesses to memory 804 requested by processor 802. In particular examples, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular examples, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular examples, storage 806 is non-volatile, solid-state memory. In particular examples, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular examples, I/O interface 808 includes hardware, software, or both, providing one or more interfaces for communication between computer system 800 and one or more I/O devices. Computer system 800 may include one or a combination of these I/O devices, where appropriate. One or a combination of of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or a combination of these I/O devices. I/O interface 808 may include one or more I/O interfaces 808, where appropriate. Although this disclosure describes and illustrates a particular I/O interface, this disclosure contemplates any suitable I/O interface.

In particular examples, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or a combination of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular examples, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

### EXAMPLES

Example 1 includes at least one computer readable storage medium comprising a set of instructions, which when executed by a computing device, cause the computing device to identify a first post that is submitted to a first group of a social network, identify that the first post is a cross-pollination candidate, identify a second group of the social network, generate a first vector that is to represent one of the first post or the first group, generate a second vector that is to represent the second group, determine whether the second group matches a cross-pollination criteria based on a comparison of the first vector to the second vector, and determine whether to automatically generate a second post based on the first post, and submit the second post to the second group based on whether the second group matches the cross-pollination criteria.

Example 2 includes the at least one computer readable storage medium of Example 1, where, to generate the first vector, the instructions, when executed, cause the computing device to apply a locality sensitive hashing process to first characteristics of the one of the first post or the first group to map the first characteristics to first buckets of a plurality of buckets, and where, to generate the second vector, the instructions, when executed, cause the computing device to apply a locality sensitive hashing process to second characteristics of the second group to map the second characteristics to second buckets of the plurality of buckets.

Example 3 includes the at least one computer readable storage medium of Example 1, where the cross-pollination criteria is whether the first vector is similar to the second vector.

Example 4 includes the at least one computer readable storage medium of Example 1, where the instructions, when executed, cause the computing device to determine content of the first post, and weight the second vector according to the content.

Example 5 includes the at least one computer readable storage medium of Example 1, where the set of instructions, which when executed by the computing identify a constraint associated with the second group, determine whether the first post meets the constraint, and determine whether the second group matches the cross-pollination criteria based on whether the first post meets the constraint.

Example 6 includes the at least one computer readable storage medium of Example 1, where the set of instructions, which when executed by the computing determine that the second post is to be automatically generated based on the first post in response to the second group matching the cross-pollination criteria, determine that one or more of the first group, the first post or the second group has a privacy restriction constraint, generate a summary of the first post in response to the one or more of the first group, the first post or the second group has a privacy restriction constraint, where the summary is to omit personal data from the first post, and set the summary as the second post, and provide the second post to the second group.

Example 7 includes the at least one computer readable storage medium of Example 1, where the set of instructions, which when executed by the computing determine that the first post does not meet a trending threshold, identify a second post from a third group that meets the trending threshold, generate a third vector based on the second post, compare the first vector and the third vector, and determine whether to propagate the first post to the third group based on the first vector being compared to the third vector.

Example 8 includes a system comprising one or more processors, and a memory coupled to the one or more processors, the memory comprising instructions executable by the one or more processors, the one or more processors being operable when executing the instructions to identify a first post that is submitted to a first group of a social network, identify that the first post is a cross-pollination candidate, identify a second group of the social network, generate a first vector that is to represent one of the first post or the first group, generate a second vector that is to represent the second group, determine whether the second group matches a cross-pollination criteria based on a comparison of the first vector to the second vector, and determine whether to automatically generate a second post based on the first post, and submit the second post to the second group based on whether the second group matches the cross-pollination criteria.

Example 9 includes the system of Example 8, where the one or more processors are further operable when executing the instructions to where, to generate the first vector, the instructions, when executed, cause the computing device to apply a locality sensitive hashing process to first characteristics of the one of the first post or the first group to map the first characteristics to first buckets of a plurality of buckets, and where, to generate the second vector, the instructions, when executed, cause the computing device to apply a locality sensitive hashing process to second characteristics of the second group to map the second characteristics to second buckets of the plurality of buckets.

Example 10 includes the system of Example 8, where the cross-pollination criteria is whether the first vector is similar to the second vector.

Example 11 includes the system of Example 8, where the one or more processors are further operable when executing the instructions to determine content of the first post, and weight the second vector according to the content.

Example 12 includes the system of Example 8, where the one or more processors are further operable when executing the instructions to identify a constraint associated with the second group, determine whether the first post meets the constraint, and determine whether the second group matches the cross-pollination criteria based on whether the first post meets the constraint.

Example 13 includes the system of Example 8, where the one or more processors are further operable when executing the instructions to determine that the second post is to be automatically generated based on the first post in response to the second group matching the cross-pollination criteria, determine that one or more of the first group, the first post or the second group has a privacy restriction constraint, generate a summary of the first post in response to the one or more of the first group, the first post or the second group having a privacy restriction constraint, where the summary is to omit personal data from the first post, and set the summary as the second post, and provide the second post to the second group.

Example 14 includes the system of Example 8, where the one or more processors are further operable when executing the instructions to determine that the first post does not meet a trending threshold, identify a second post from a third group that meets the trending threshold, generate a third vector based on the second post, compare the first vector and the third vector, and determine whether to propagate the first post to the third group based on the first vector being compared to the third vector.

Example 15 includes a method comprising identifying a first post that is submitted to a first group of a social network, identifying that the first post is a cross-pollination candidate, identifying a second group of the social network, generating a first vector that is to represent one of the first post or the first group, generating a second vector that is to represent the second group, determining whether the second group matches a cross-pollination criteria based on a comparison of the first vector to the second vector, and determining whether to automatically generate a second post based on the first post, and submit the second post to the second group based on whether the second group matches the cross-pollination criteria.

Example 16 includes the method of Example 15, further comprising where the generating the first vector includes applying a locality sensitive hashing process to first characteristics of the one of the first post or the first group to map the first characteristics to first buckets of a plurality of buckets, and where the generating the second vector includes applying a locality sensitive hashing process to second characteristics of the second group to map the second characteristics to second buckets of the plurality of buckets.

Example 17 includes the method of Example 15, where the cross-pollination criteria is whether the first vector is similar to the second vector.

Example 18 includes the method of Example 15, further comprising determining content of the first post, and weighting the second vector according to the content.

Example 19 includes the method of Example 15, further comprising identifying a constraint associated with the second group, determining whether the first post meets the constraint, and determining whether the second group matches the cross-pollination criteria based on whether the first post meets the constraint.

Example 20 includes the method of Example 15, further comprising determining that the second post is to be automatically generated based on the first post in response to the second group matching the cross-pollination criteria, determining that one or more of the first group, the first post or the second group has a privacy restriction constraint, generating a summary of the first post in response to the one or more of the first group, the first post or the second group has a privacy restriction constraint, where the summary is to omit personal data from the first post, and setting the summary as the second post, providing the second post to the second group, determining that the first post does not meet a trending threshold, identifying a second post from a third group that meets the trending threshold, generating a third vector based on the second post, comparing the first vector and the third vector, and determining whether to propagate the first post to the third group based on the first vector being compared to the third vector.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Examples are applicable for use with all types of semiconductor integrated circuit (“IC”) chips. Examples of these IC chips include but are not limited to processors, controllers, chipset components, programmable logic arrays (PLAs), memory chips, network chips, systems on chip (SOCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary examples to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although examples are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the examples. Further, arrangements may be shown in block diagram form in order to avoid obscuring examples, and also in view of the fact that specifics with respect to implementation of such block diagram arrangements are highly dependent upon the computing system within which the example is to be implemented, i.e., such specifics should be well within purview of one skilled in the art. Where specific details (e.g., circuits) are set forth in order to describe example examples, it should be apparent to one skilled in the art that examples can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the examples can be implemented in a variety of forms. Therefore, while the examples have been described in connection with particular examples thereof, the true scope of the examples should not be so limited since other modifications will become apparent to the skilled practitioner upon a study of the drawings, specification, and following claims.

We claim:

1. At least one computer readable storage medium comprising a set of instructions, which when executed by a computing device, cause the computing device to:
identify a first post that is submitted to a first group of a social network;
identify that the first post is a cross-pollination candidate;
identify a second group of the social network;
generate a first vector that is to represent one of the first post or the first group;
generate a second vector that is to represent the second group;
determine whether the second group matches a cross-pollination criteria based on a comparison of the first vector to the second vector; and
determine whether to automatically generate a second post based on the first post, and submit the second post to the second group based on whether the second group matches the cross-pollination criteria.

2. The at least one computer readable storage medium of claim 1,
wherein, to generate the first vector, the instructions, when executed, cause the computing device to apply a locality sensitive hashing process to first characteristics of the one of the first post or the first group to map the first characteristics to first buckets of a plurality of buckets; and
wherein, to generate the second vector, the instructions, when executed, cause the computing device to apply a locality sensitive hashing process to second characteristics of the second group to map the second characteristics to second buckets of the plurality of buckets.

3. The at least one computer readable storage medium of claim 1, wherein the cross-pollination criteria is whether the first vector is similar to the second vector.

4. The at least one computer readable storage medium of claim 1, wherein the instructions, when executed, cause the computing device to:
determine content of the first post; and
weight the second vector according to the content.

5. The at least one computer readable storage medium of claim 1, wherein the set of instructions, which when executed by the computing:
identify a constraint associated with the second group;
determine whether the first post meets the constraint; and
determine whether the second group matches the cross-pollination criteria based on whether the first post meets the constraint.

6. The at least one computer readable storage medium of claim 1, wherein the set of instructions, which when executed by the computing:
determine that the second post is to be automatically generated based on the first post in response to the second group matching the cross-pollination criteria;
determine that one or more of the first group, the first post or the second group has a privacy restriction constraint;
generate a summary of the first post in response to the one or more of the first group, the first post or the second group has a privacy restriction constraint, wherein the summary is to omit personal data from the first post; and
set the summary as the second post; and
provide the second post to the second group.

7. The at least one computer readable storage medium of claim 1, wherein the set of instructions, which when executed by the computing:
determine that the first post does not meet a trending threshold;
identify a second post from a third group that meets the trending threshold;
generate a third vector based on the second post;
compare the first vector and the third vector; and
determine whether to propagate the first post to the third group based on the first vector being compared to the third vector.

8. A system comprising:
one or more processors; and
a memory coupled to the one or more processors, the memory comprising instructions executable by the one or more processors, the one or more processors being operable when executing the instructions to:
identify a first post that is submitted to a first group of a social network;
identify that the first post is a cross-pollination candidate;
identify a second group of the social network;
generate a first vector that is to represent one of the first post or the first group;
generate a second vector that is to represent the second group;
determine whether the second group matches a cross-pollination criteria based on a comparison of the first vector to the second vector; and
determine whether to automatically generate a second post based on the first post, and submit the second post to the second group based on whether the second group matches the cross-pollination criteria.

9. The system of claim 8, wherein the one or more processors are further operable when executing the instructions to:
wherein, to generate the first vector, the instructions, when executed, cause the computing device to apply a locality sensitive hashing process to first characteristics of the one of the first post or the first group to map the first characteristics to first buckets of a plurality of buckets; and
wherein, to generate the second vector, the instructions, when executed, cause the computing device to apply a locality sensitive hashing process to second characteristics of the second group to map the second characteristics to second buckets of the plurality of buckets.

10. The system of claim 8, wherein the cross-pollination criteria is whether the first vector is similar to the second vector.

11. The system of claim 8, wherein the one or more processors are further operable when executing the instructions to:
determine content of the first post; and
weight the second vector according to the content.

12. The system of claim 8, wherein the one or more processors are further operable when executing the instructions to:
identify a constraint associated with the second group;
determine whether the first post meets the constraint; and
determine whether the second group matches the cross-pollination criteria based on whether the first post meets the constraint.

13. The system of claim 8, wherein the one or more processors are further operable when executing the instructions to:
determine that the second post is to be automatically generated based on the first post in response to the second group matching the cross-pollination criteria;
determine that one or more of the first group, the first post or the second group has a privacy restriction constraint;
generate a summary of the first post in response to the one or more of the first group, the first post or the second group having a privacy restriction constraint, wherein the summary is to omit personal data from the first post; and
set the summary as the second post; and
provide the second post to the second group.

14. The system of claim 8, wherein the one or more processors are further operable when executing the instructions to:
determine that the first post does not meet a trending threshold;
identify a second post from a third group that meets the trending threshold;
generate a third vector based on the second post;
compare the first vector and the third vector; and
determine whether to propagate the first post to the third group based on the first vector being compared to the third vector.

15. A method comprising:
identifying a first post that is submitted to a first group of a social network;
identifying that the first post is a cross-pollination candidate;
identifying a second group of the social network;
generating a first vector that is to represent one of the first post or the first group;
generating a second vector that is to represent the second group;
determining whether the second group matches a cross-pollination criteria based on a comparison of the first vector to the second vector; and
determining whether to automatically generate a second post based on the first post, and submit the second post to the second group based on whether the second group matches the cross-pollination criteria.

16. The method of claim 15, further comprising:
wherein the generating the first vector includes applying a locality sensitive hashing process to first characteristics of the one of the first post or the first group to map the first characteristics to first buckets of a plurality of buckets; and
wherein the generating the second vector includes applying a locality sensitive hashing process to second characteristics of the second group to map the second characteristics to second buckets of the plurality of buckets.

17. The method of claim 15, wherein the cross-pollination criteria is whether the first vector is similar to the second vector.

18. The method of claim 15, further comprising:
determining content of the first post; and
weighting the second vector according to the content.

19. The method of claim 15, further comprising:
identifying a constraint associated with the second group;
determining whether the first post meets the constraint; and
determining whether the second group matches the cross-pollination criteria based on whether the first post meets the constraint.

20. The method of claim 15, further comprising:
determining that the second post is to be automatically generated based on the first post in response to the second group matching the cross-pollination criteria;
determining that one or more of the first group, the first post or the second group has a privacy restriction constraint;
generating a summary of the first post in response to the one or more of the first group, the first post or the second group has a privacy restriction constraint, wherein the summary is to omit personal data from the first post; and
setting the summary as the second post;
providing the second post to the second group;
determining that the first post does not meet a trending threshold;
identifying a second post from a third group that meets the trending threshold;
generating a third vector based on the second post;
comparing the first vector and the third vector; and
determining whether to propagate the first post to the third group based on the first vector being compared to the third vector.
